(19) United States
(12) Patent Application Publication
(10) Pub. No.: US 2012/0013102 A1
(43) Pub. Date: Jan. 19, 2012

(54) Sliding Seat for Wheelchair Occupant to Enter and Exit Motor Vehicles

(76) Inventor: Frank Fang Gao, (US)

(21) Appl. No.: 13/184,493

(22) Filed: Jul. 16, 2011

Related U.S. Application Data
(60) Provisional application No. 61/365,333, filed on Jul. 18, 2010.

(51) Int. Cl. A61G 5/10

(52) U.S. Cl. 280/304.1

(57) ABSTRACT

A sliding seat, being manufactured either together with a wheelchair as a component or separately as an accessory to a used wheelchair and aiming at helping a wheelchair occupant enter into or exit from a motor vehicle, comprises a supporting rack, a siding cushion, and an extender. The supporting rack has a top-board, a bottom frame, and a hoisting device in between. On the upward surface of the top-board, there are two crosswise sliding rulers. The sliding cushion has a soft cushion top and a solid baseboard which has two sliding sleeves on its downward surface to sheathe the sliding rulers of the top-board of the supporting rack. The extender also has two crosswise sliding rulers, which can connect with or disconnect from the sliding rulers of the top-board of the supporting rack. When being connected, the extender extends the two elongated sliding rulers into an open-door motor vehicle and lays them on the vehicle seat. Then, on the elongated sliding rulers, the sliding cushion and the wheelchair occupant on it can slide from the supporting rack into the vehicle and sit on the vehicle seat, or from the vehicle seat back onto the supporting rack.

### CROSS-REFERENCE TO RELATED APPLICATIONS

This application claims priority from U.S. Provisional Application Ser. No. 61/365,333 filed on Jul. 18, 2010, and the contents of which are incorporated herein by reference in its entirety.

### STATEMENT REGARDING FEDERALLY SPONSORED RESEARCH OR DEVELOPMENT

Not applicable.

### FIELD OF THE INVENTION

The present invention, in general, relates to the field of wheelchairs, and more specifically, to a wheelchair sliding seat that assists wheelchair occupants to enter into and exit from motor vehicles.

### BACKGROUND OF THE INVENTION

Conventional wheelchairs have been widely used nowadays to help move disabled people around, thus improving their mobility, enhancing their capability to participate in society's social and cultural activities, and thus enriching their daily life. Some wheelchairs need another person to push, while some others are equipped with two large rear wheels with hand-rims for their occupants, who can use their arms and hands to turn the hand-rims to move the wheelchairs. There are also various kinds of automatic or powered wheelchairs, which are moved by battery packages being installed on the wheelchairs.

Conventional wheelchairs, however, are good transportation tools for short-distance activities only. For activities at far-away destinations, transporting a disabled person with a wheelchair alone, whether a manual one or a powered one, is difficult, very time-consuming, and oftentimes even impossible. The wheelchaired person still needs to ride a motor vehicle to reach those far-away destinations. One common method is to move the wheelchair and its occupant together into a specially modified vehicle, such as a bus or a van that has an ample interior space for accepting the wheelchair and its occupant. For example, many mini-vans on the market can be commercially modified by removing one or two original passenger seats to make room for wheelchair, installing some accessories such as an elevating lift or a ramp plate and pulling and fastening equipments, and adding necessary controlling and operating mechanisms. Modifications to various vehicles based on this method can be found at U.S. Pat. Nos. 4,299,527; 4,479,753; 4,542,917; 5,466,111; 5,542,811; and 6,726,435. Two major advantages of this method are: (1) the wheelchair occupants can stay seated in the wheelchair; and (2) moving into and out from the vehicle is easy and needs only a little second-hand help, especially when such moving is assisted by the power from the vehicle. However, some disadvantages are also associated with this method, including: (1) modification of such vehicles to accommodate wheelchair is very expensive, usually in the range of several thousands dollars; (2) such modification significantly reduce the interior space of the vehicle for other purposes; (3) such modification is limited to only mini-vans or bigger vehicles, and excludes the most commonly used family vehicles, that is, passenger cars; and (4) the wheelchair and its occupant are bound to the modified van, which significantly reduces the flexibility and usability of the vehicle for other people and/or purposes.

Another method for long distance transportation is to separate the wheelchair and its occupant, then transfer the occupant only into a motor vehicle, and stow the wheelchair, preferably in a folded form, in the vehicle's rear trunk. An obvious advantage of this method is that it makes almost all passenger vehicles, even including some small-size sedans, available for transportation of disabled people over long distances. However, this method often presents some difficulties. First, moving a disabled adult person off the wheelchair means lifting and moving a heavy weight, oftentimes more than 100 pounds. Second, the height of the wheelchair seat and the vehicle seat are oftentimes different, and space around vehicle doorways is relatively small. Therefore how to move a disabled person off wheelchair and into the vehicle needs great efforts and cares. Third, when arriving at destination, transferring the disabled person from inside the vehicle back to the wheelchair requires the same efforts and cares. In general, to overcome these difficulties for a safe and careful transportation needs help from at least two normal adults. In addition, the most undesirable feature is that such transferring process often makes the wheelchair occupant suffer both physically and psychologically.

There have been a very limited amount of efforts in the present art that aims at, or has potential use for, helping move disabled people off their wheelchairs and then into a vehicle, and vice versa. U.S. Pat. No. 6,129,403 discloses a folding entry seat that can be relatively easily installed on the outer side of a vehicle seat, extending the existing vehicle seat outward for a better access for a disabled person after he or she leaves the wheelchair. While this folding seat extension may help a disabled person feel easier to move into or out from an existing vehicle seat, it does not help at all in moving a disabled person off or on the wheelchair. U.S. Pat. No. 7,641,217 B2 discloses a structure that could support a wheelchair seat and adjust the height of it to that of a vehicle seat. Such a design can save some of the helpers' lifting efforts when moving the disabled person off or back onto the wheelchair. However, the helpers still need to lift the disabled person and separate his/her body from the wheelchair. In addition, this design cannot provide help in the process of moving the disabled person into or out from the vehicle. Further, this design involves a motor-driven mechanism for adjusting the height of wheelchair seat with the occupant on it, which indicates that a strong on-board power source (such as a battery package) is necessary, leading to a significant additional cost to fulfill this design of limited practical use.

Apparently, there exists an urgent need in the present art of wheelchair to provide an easy and convenient method, effective in both cost and performance, to help transfer disabled people from wheelchairs into motor vehicles, and vice versa.

### SUMMARY OF THE INVENTION AND ADVANTAGES

The present invention aims at addressing the aforementioned need to transfer disabled people between their wheelchairs and motor vehicles in which they ride to distant destinations. More specifically, the present invention provides a sliding seat, either as a component seat but detachable from wheelchair, or as an accessory seat separate from wheelchair. Sitting on this sliding seat, a wheelchair occupant can enter or exit a motor vehicle without leaving the seat cushion, therefore avoiding the labor-intensive lifting need. Operation of this sliding seat can be done by manual efforts, and can be done by one adult helper, who can be conveniently the driver of transporting vehicle.

The sliding seat of the present invention comprises a seating means, a supporting rack and a sliding means. The seating means is a soft cushion fixed on an underlining baseboard, which, on its upward surface, has a pair of rods for sustaining the soft cushion, and on its downward surface, has two crosswise sliding sleeves. The supporting rack consists of a horizontal top-board and a horizontal bottom frame, both in a rectangular shape. The top-board and the bottom frame are connected with a hoisting device which is manually operated to adjust the vertical distance between the top-board and the bottom frame. The sliding means includes a pair of crosswise sliding rulers fixed on the upward surface of the top-board of the supporting rack, and a pair of sliding rulers fixed on an extender. The two sliding sleeves of the aforementioned cushion baseboard sit in the sliding rulers on the top-board. The extender is a rectangular frame that can be attached to or detached from the top-board of the supporting rack. When being attached, the extender connects its two sliding rulers with the two sliding rulers of the top-board of the supporting rack, making an elongated pair of sliding rulers that extend into a vehicle and sit on a vehicle seat. Thus, the soft cushion and its baseboard can slide from the supporting rack into a vehicle and sit on a vehicle seat. When detached, the extension frame can be folded and stowed under the top-board of the supporting rack. The bottom frame of the supporting rack has one all-direction wheel under each of its four corners. For stability purpose, the four corresponding corners of the top-board and the bottom frame of the supporting rack are connected with sheathe-type columns.

The sliding seat of the present invention described above can be a component of a new wheelchair. When in normal use, a disabled person is sitting on the sliding seat which itself is engaged on the wheelchair main frame. The supporting rack is under the seating means, and the four all-direction wheels of the supporting rack are kept several inches above the ground.

When the wheelchair occupant needs to enter a vehicle, the corresponding vehicle door is opened widely first, then the wheelchair is pushed as close as possible to the side of the vehicle behind the open door. A helper operates manually the hoisting device of the supporting rack to lower its bottom frame until its four wheels reach the ground. After the wheels reach the ground, the helper continues operating the hoisting device to raise the top-board of the supporting rack until the sliding seat is disengaged from the wheelchair main frame. The occupant on the sliding seat is supported by the supporting rack only. At this point, the helper can pull the wheelchair backward to separate the wheelchair from the sliding seat. Then, the helper can operate the hoisting device again to adjust the height of the sliding seat to that of the vehicle seat. Then, the helper takes out the extender and attaches it to the top-board of the supporting rack, with its sliding rulers lying on the vehicle seat where the disabled person will sit. At this point, the helper can make necessary small movements of the supporting rack to a position in which the disabled person feels comfortable during the sliding process to follow. Such small movements can be easily done due to the four all-direction wheels of the supporting rack. After this position adjustment, the wheelchair occupant can enter the vehicle easily while the helper pushes the seating means on the elongated sliding rulers. After entering the vehicle, the occupant will buckle up on the seating means, which sits on the elongated sliding rulers on the vehicle seat. Then, the extension frame is detached from the supporting rack, and folded up to allow the vehicle door to close. Both wheelchair and supporting rack can then be stowed in the vehicle's rear trunk. The occupant and his/her equipment (wheelchair and supporting rack) are ready for a long-distance ride.

Upon arriving at the destination, an opposite process is followed to help the occupant exit the vehicle. After being unloaded from the vehicle rear trunk, the supporting rack is first placed to the same position by the vehicle. The extender is folded down and attached to the supporting rack to resume connection of the sliding rulers. Then, the occupant, after being unbuckled, can easily exit the vehicle while the helper pulls the seating means on the elongated sliding rulers. After the occupant is seated safely on the supporting rack, the extender is detached from the supporting rack, and the supporting rack is moved away slightly from the vehicle, where the occupant can still use his/her hand to hold the vehicle door frame for stability. Then, the helper can operate the hoisting device to adjust the top-board of the supporting rack to a height at which the wheelchair can be moved underneath. After the wheelchair is placed underneath the top-board of the supporting rack, the top-board is lowered for reengagement by operating the hoisting device. After the reengagement, further operation of the hoisting device will raise the four wheels of the supporting rack. At this point, the extender can be removed from the vehicle seat and then stowed on the bottom frame of the supporting rack. The wheelchair occupant is ready for leaving for desired activities, and the vehicle itself is ready for its parking.

In reality, there are many wheelchairs already in use (i.e., used wheelchairs) in the society to help disabled people. For those wheelchair occupants to enjoy the benefits of the present invention, the sliding seat of the present invention can be manufactured, with or without minor alternations, as a separate accessory to an existing wheelchair. When a disabled person needs to enter a motor vehicle, this accessory sliding seat is first adjusted to a height equal to the height of the wheelchair seat and then placed behind the open door of a vehicle. The wheelchair is then moved to behind the sliding seat, with the front edge of the wheelchair seat in touch with the rear edge of the sitting cushion of the accessory sliding seat. At this point, the occupant's two legs are placed on the top of the accessory sliding seat, and then the body of the occupant is moved forward onto the accessory sliding seat. Most of the time, the two arms of the disabled person can still function properly and therefore play a major role in this body relocation. After the occupant is seated safely on the accessory sliding seat, the wheelchair can be moved backward and away from the accessory sliding seat. From this point, the process is the same as described in the previous paragraphs for the component sliding seat. When the disabled person needs to exit the vehicle and go back on the wheelchair, the similar backward process is followed, except the last step will involve moving the body of the occupant from the accessory sliding seat back to the wheelchair seat. The sliding seat as a separate accessory can be stowed in the vehicle's rear trunk or other convenient places.

The advantages of the present invention include the following. First, with the present invention as a component of a new wheelchair, the wheelchair occupant will no longer have to leave the wheelchair seat cushion when entering or exiting a motor vehicle, thus completely avoiding the need of lifting the body of the occupant. When the present invention is provided as an accessory, the lifting effort for relocation can be significantly reduced, particularly when the two arms of the wheelchair occupant can still function properly. Secondly, the difference in height between the wheelchair occupant's seat and the vehicle seat can be adjusted by a hoisting device that can be operated manually and easily by an adult helper. Although a powered hoisting device may be an alternative, its use is no longer a necessity. Thirdly, the sliding mechanism of the present invention makes the vehicle entering or exiting process so simple and labor-saving that one adult helper can easily handle. Fourthly, the present invention will make the long-distance transportation of wheelchair occupants practically feasible with a much wider range of motor vehicles, including some compact cars because at least the front passenger seats of those compact cars can be readily used with the present invention. Finally, and most importantly, the present invention provides a sliding process in which a wheelchair occupant can transfer from the wheelchair into a motor vehicle, or from inside the vehicle back to wheelchair, with minimum body position changes, and thus minimum physical and psychological discomforts. With all those advantages, the present invention is expected to significantly enhance the moving ability of disabled people, thus enabling them to enjoy with, and contribute to, more and more the societal activities, public welfares, and modern civilization.

The sliding seat of the present invention will lead to a cost-effective improvement in the present arts of wheelchairs and related equipments for wheelchaired people to enter or exit motor vehicles because (1) it does not require any powered part or mechanism, although some powered devices may be alternative; (2) it does not require any alternation or equipment installation on the vehicle end; (3) its design and structure are relatively simple, and therefore can be easily manufactured in a wheelchair factory with existing equipments. In addition, using the sliding seat of the present invention will lead to other savings, including savings from every step of transporting a wheelchaired person for a long distance, plus savings in time, effort and man-power needed.

The wheelchair being associated with the present invention should be foldable so that it can be easily stowed in vehicle's trunk and transported together with the wheelchair occupant.

### BRIEF DESCRIPTION OF THE DRAWINGS

FIG. 1 is a perspective view of the sliding seat of the present invention, where the sliding seat is separate from the wheelchair and adjacent to a vehicle's seat.

FIG. 2 is a perspective view of the structural components of the supporting rack of the present invention.

FIG. 3 is a detailed view of Section A of FIG. 2.

FIG. 4 is a perspective view of the sliding cushion.

FIG. 5 is a perspective view of the extender.

FIG. 6 is a detailed view of Section B of FIG. 5.

FIG. 7 is a front view of the sliding seat of the present invention as a component of a wheelchair and being engaged in the main frame of the wheelchair.

FIG. 8 is a detailed view of Section C of FIG. 7.

### DETAILED DESCRIPTION OF THE PREFERRED EMBODIMENT

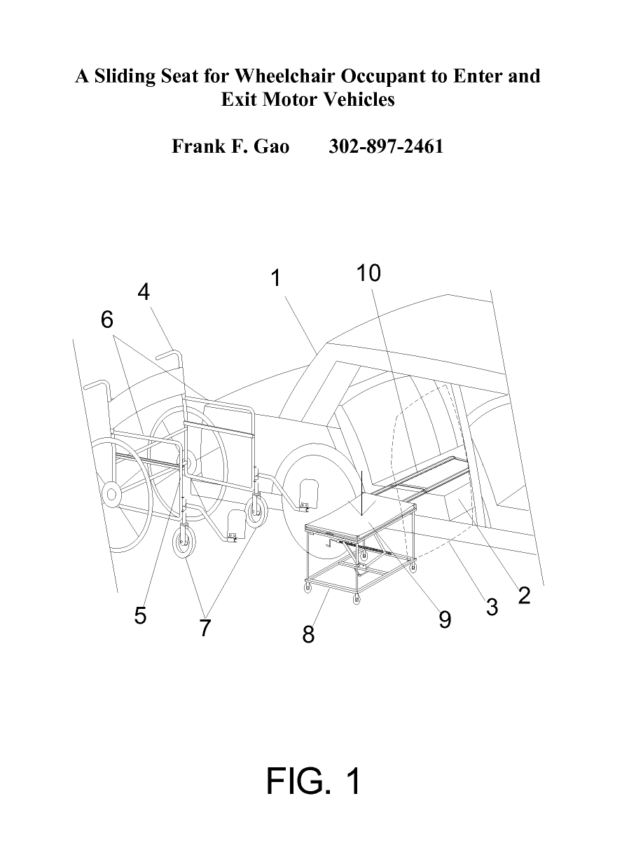

The description herein is presented progressively along with FIG. 1 through FIG. 8, in which the same numerals are used to identify the same components of the invention embodiments. A List of component numbers and names is provided for convenience purpose at the end of this description section.

In FIG. 1 are shown a motor vehicle 1, a passenger seat 2 of the said vehicle, a door 3 of the said vehicle, a wheelchair 4 and its main frame 5, armrests 6 of the said wheelchair, front wheels 7 of the said wheelchair. Note that parts 1 through 7 are designated herein for demonstration purpose only, and are not components of the present invention. Note also that said vehicle 1 can be other types (such as station vegans, jeeps, SUVs, pick-ups, etc) and said passenger seat can be either a rear seat or front seat. FIG. 1 also shows that the sliding seat of the present invention consists of a supporting rack 8, a sliding cushion 9, and an extender 10. As shown in FIG. 1, said supporting rack 8, with said sliding cushion 9 on it, is separated from the main frame of the wheelchair, and is placed adjacent to said vehicle 1, wherein said extender 10 is placed on said vehicle seat 2 and connected with said supporting rack 8. A wheelchair occupant sitting on said sliding cushion 9, who is not shown in FIG. 1 but whose body weight is represented by a downward arrow, is ready for sliding along said extender 10 onto said vehicle seat 2 of said vehicle 1.

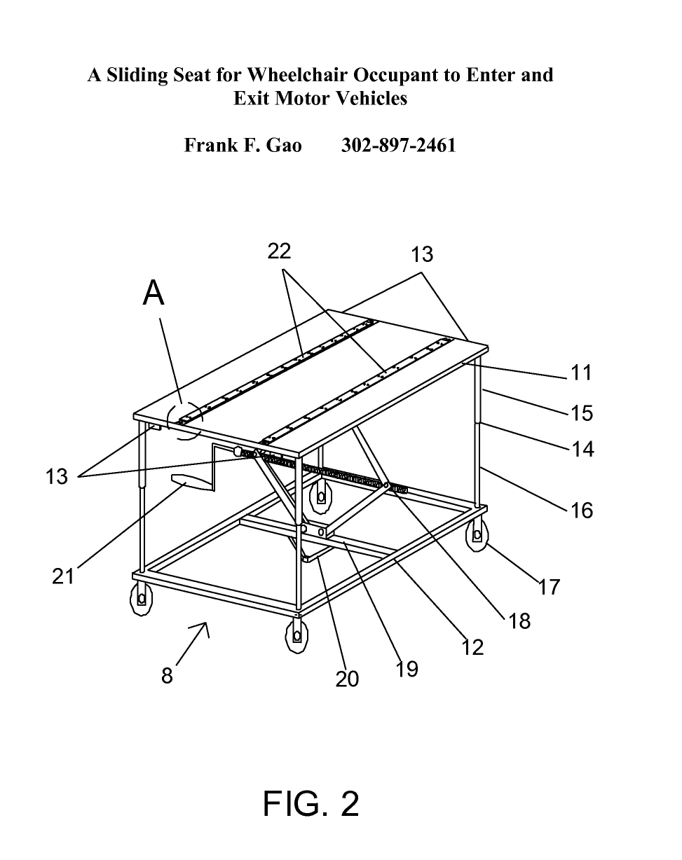

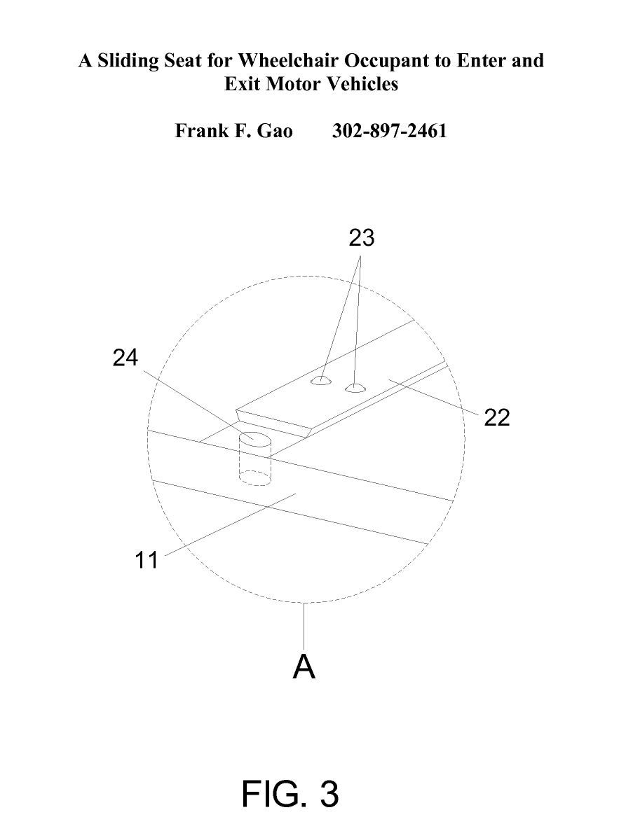

FIG. 2 shows the structural components and their connections of said supporting rack 9, and FIG. 3 shows details of Section A of FIG. 2. As shown in FIG. 2 and FIG. 3, said supporting rack has a top-board 11 and a bottom frame 12. Said top-board 11 has at each edge two engagement hooks 13 (the two engagement hooks at the far end in FIG. 2 are not shown but only positioned). Between each pair of corresponding corners of said top-board 11 and said bottom frame 12, there is a sheath-type supporting column 14, with its outer sheath 15 being fixed with the top-board and its inner column 16 fixed with the bottom frame. Under each corner of said bottom frame 12, there is a small all-direction wheel 17. In the middle portion of the said supporting rack, there is a hoisting device 18 which sits between said top-board 11 and said bottom frame 12 on a horizontal bar 19 with a triangular support 20 underneath. Said hoisting device 18 is operated manually by turning a handle 21, which is detachable from said hoisting device 18. On the upward surface of said top-board 11, there are two crosswise sliding rulers 22, each having on its surface a group of imbedded sliding beads 23. At the end of each said sliding ruler 22, there is a connection pinhole 24 (see FIG. 3). Note that the hand-operated hoisting device 18 in FIG. 2 is for demonstration purpose only. Other hoisting devices, such as a foot-operated hydraulic device, may be used in practice.

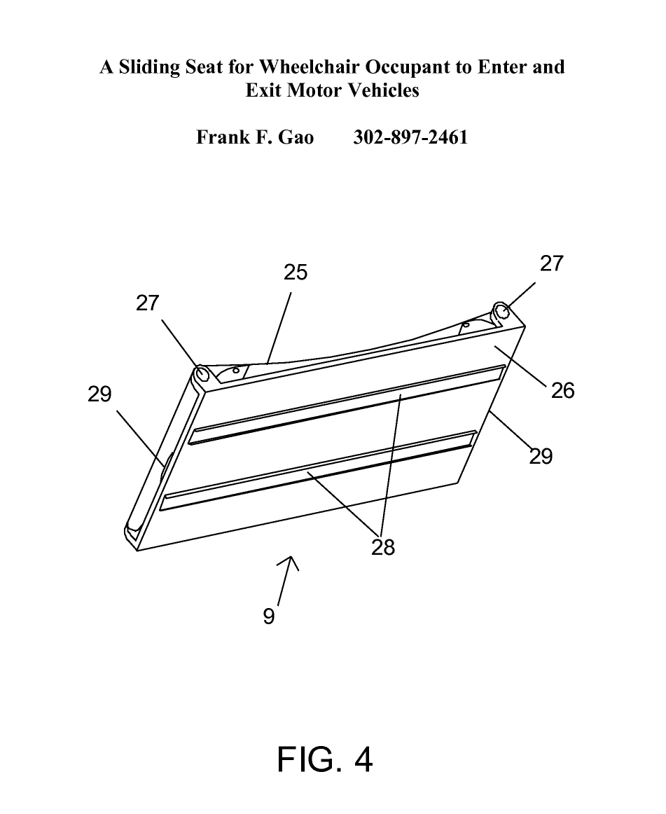

As shown in FIG. 3, said sliding ruler 22 has a reverse trapezoid cross-section, which is to match the trapezoid cross-section of two sliding sleeves of said sliding cushion 9 (see FIG. 4).

FIG. 4 is a perspective view of said sliding cushion 9 of the present invention. Shown in FIG. 4 are a soft cushion top 25, a solid cushion baseboard 26, two cushion holding bars 27, two sliding sleeves 28, and two cushion handles 29 (the cushion handle at the far end in FIG. 4 is not shown but only positioned). Said two sliding sleeves 28 have a trapezoid cross-section that enables the sliding sleeves to securely sheathe said two sliding rulers 22 in FIG. 2 and FIG. 3.

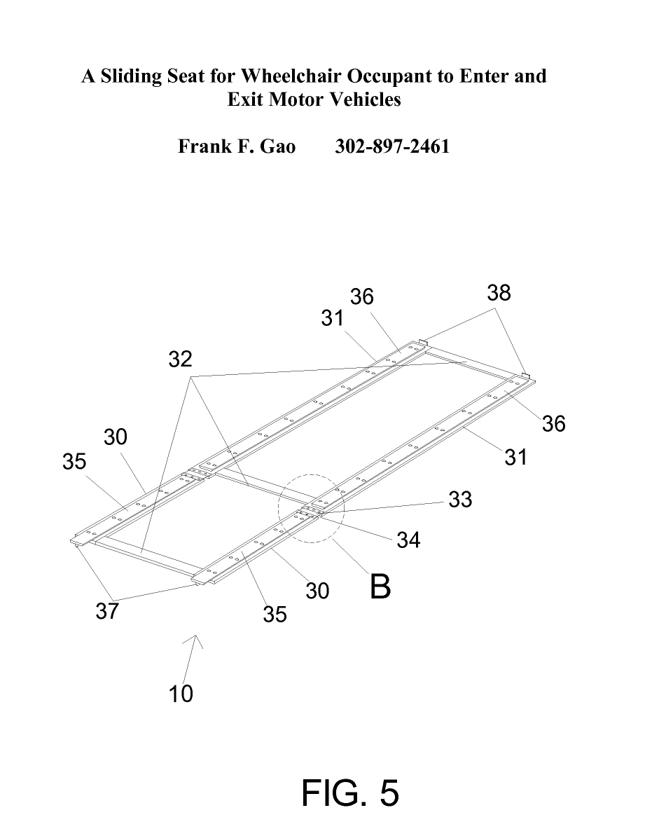

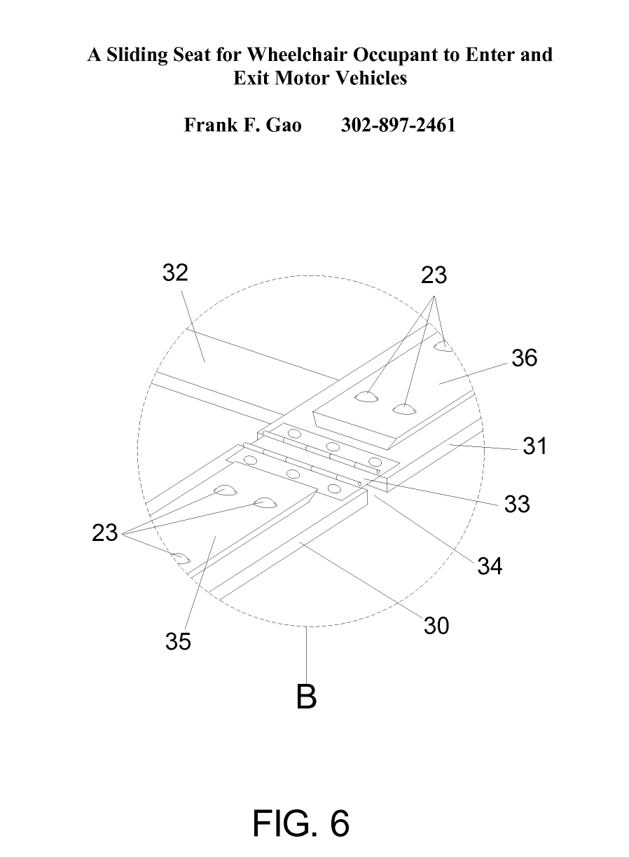

FIG. 5 shows said extender 10 of the present invention, and FIG. 6 shows the details of Section B of FIG. 5. As shown in FIG. 5 and FIG. 6, said extender 10 has two short frame members 30, two long frame members 31, and three cross members 32, and those said members are connected as shown in FIG. 5. One said short frame member 30 and one said long frame member 31 are connected with a fixed double-bending hinge 33 which creates a gap 34 between said short frame member 30 and said long frame member 31. On each said short frame member 30 is fixed a short sliding ruler 35. On each said long frame member 31 is fixed a long sliding ruler 36. Each of said short sliding rulers 35 and said long sliding rulers 36 has on its surface a group of imbedded sliding beads 23. Beneath the outer end of each said short sliding ruler 35, there is a connection pin 37 which is used to pin in said connection pinhole 24 in FIG. 2 and FIG. 3. At the outer end of each said long sliding ruler 36, there is a sliding cushion stopper 38 which is to stop said sliding cushion 9 in FIG. 4. Close observations of various vehicles by this inventor have revealed that the total length of the extender should be about 30 inches (75 cm), while the length of the short frame members should be about 10 inches (about 25 cm), and the length of the long frame members should be about 20 inches (50 cm).

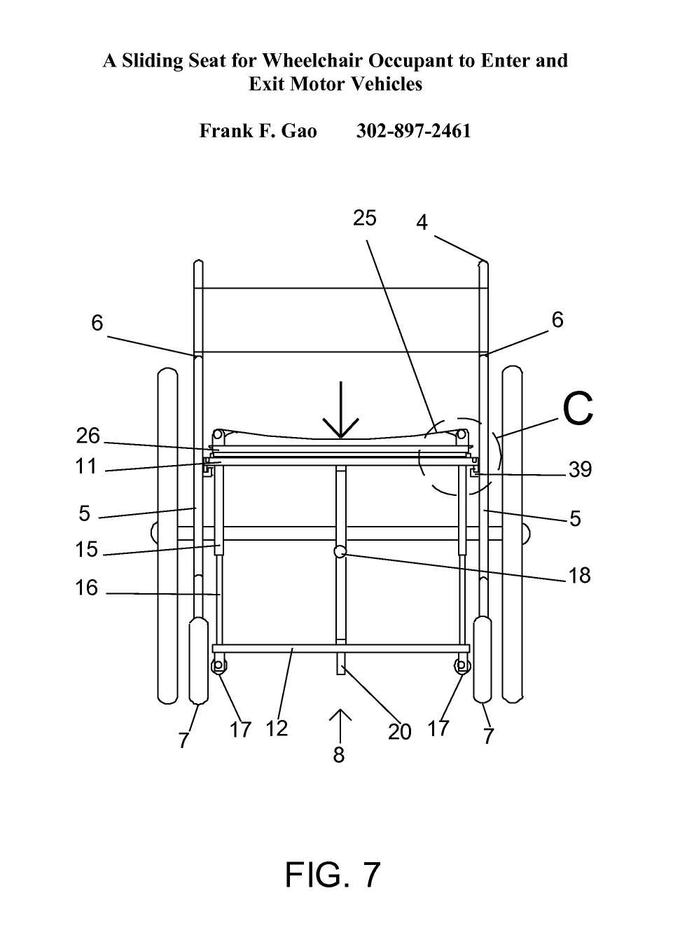

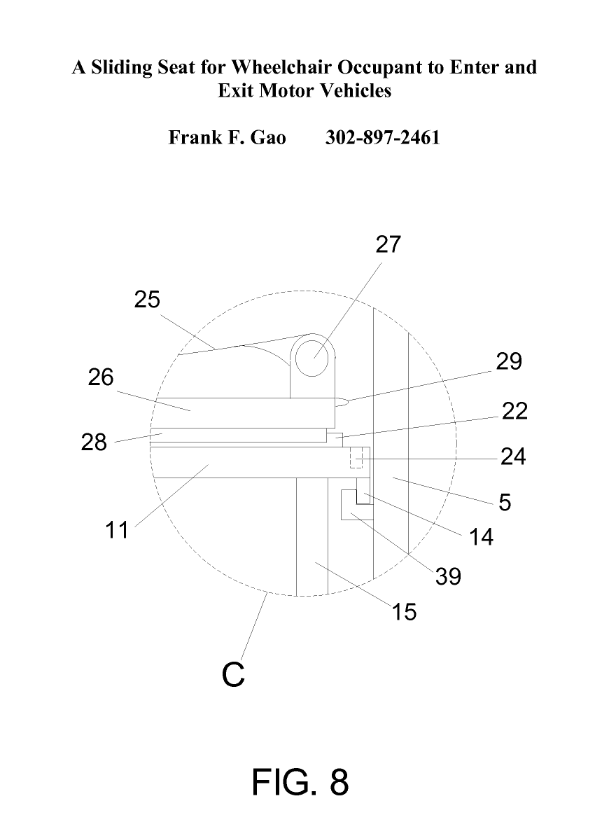

FIG. 7 shows that said supporting rack 8 of the present invention is engaged in said main frame 5 of said wheelchair 4. Said main frame 5 has an L-shaped engagement bar 39 under each said armrest 6. FIG. 8 shows the details of Section C of FIG. 7. As shown in FIG. 8, said engagement hooks 13 (see FIG. 2) are engaged with said engagement bar 39, said baseboard 26 of the sliding cushion sits on the top of said top-board 11 of the supporting rack, with said sliding sleeve 28 sheathing with said sliding ruler 22 of said top-board 11 of the supporting rack.

Separation of said supporting rack 8, with said sliding cushion 9 on it, from said wheelchair 4 is manually performed as follows. After the wheelchair is positioned at the side of the vehicle, a helper turns said handle 21 of said hoisting device 18 from behind the wheelchair. Said bottom frame 12 moves downward while said top-board 11 stays still due to the body weight on the sliding cushion. When four said wheels 17 touch the ground, said bottom frame 12 stops. At this point, said triangular support 20 touches the ground as well, providing a strong support for the hoisting device and the body weight. Further but brief turning of said handle 21 raises said top-board 11 and the body weight, and makes four said engagement hooks 13 of the supporting rack off said L-shaped engagement bars 39 of the main frame of the wheelchair. At this point, the helper stops turning said handle 21, and pulls the wheelchair backward until it separates completely from the supporting rack. As shown in FIG. 7, the space between two said front wheels 7 of the wheelchair is greater than the crosswise distance between two said all-direction wheels 17 of the supporting rack.

After separating the sliding seat from the wheelchair, said extender 10 is installed, with its two long frame members 31 being laid on said vehicle seat 2 and its two short frame members 30 being connected with said top-board 11 of the supporting rack by pushing said connection pins 37 into said connection pinholes 24. Thus, said sliding rulers 22 on the supporting rack, said short sliding rulers 35 and said long sliding rulers 36 of the extender are combined to form an elongated pair of sliding rulers, which allows said sliding cushion 9, with the wheelchair occupant on it, to slide from the supporting rack onto said vehicle seat 2.

What is claimed is:

1. A sliding seat and an associated wheelchair, wherein said sliding seat is a component of said wheelchair which has two L-shaped engagement bars under its armrests, and said sliding seat is held on said engagement bars.

2. Said sliding seat of claim 1 further comprising
a supporting rack which comprises a solid rectangular top-board on which two crosswise sliding rulers are fixed in parallel, a solid rectangular bottom frame, a manual or power-driven hoisting device between said top-board and said bottom frame to adjust vertical distance between said top-board and said bottom frame, one sheath-type column to connect each pair of corners between said top-board and said bottom frame, and one all-direction wheel being fixed beneath each corner of said bottom frame;
a sliding seat cushion which comprises a soft cushion top and a solid rectangular baseboard, and said cushion top is held above said baseboard by two holding bars being fixed at left end and right end of said baseboard, two crosswise sliding sleeves being fixed in parallel underneath said baseboard and said sliding sleeves being securely sheathed with said sliding rulers on said top-board of the supporting rack, and one handle at each of left edge and right edge of said baseboard;
an extender which comprises two short framing members being connected at their one ends with one cross member, two long framing members being connected at both ends with two cross members, said two short framing members and said two long framing members are connected at their inner ends with a pair of double-bending hinge, each of said short framing members has a short sliding ruler being fixed on it, and each of long framing members has a long sliding ruler being fixed on it.

3. The sliding seat of claims 1 and 2 further comprising a pair of engagement hooks at each edge of said top-board of said supporting rack, and said engagement hooks being engaged with said engagement bars of said wheelchair.

4. The sliding seat of claims 1 and 2 further comprising a horizontal bar being fixed between mid-points of two opposite members of said bottom frame of said supporting rack, and a triangular support being fixed underneath said horizontal bar to support said hoisting device.

5. The sliding seat of claims 1 and 2 further comprising a connection pin at each outer end of said short sliding ruler of the extender, and a connection pinhole at each end of each said sliding ruler on said top-board of the supporting rack to accommodate said connection pin so that the extender and the supporting rack are connected.

6. The extender of claim 2 further comprising a stopper at outer end of each said long sliding ruler of the extender.

7. A sliding seat, as an accessory to a used wheelchair, comprising a supporting rack, a sliding seat cushion, and an extender of claims 2, 4, 5 and 6, with or without engagement hooks of claim 3.
